(19) United States
(12) Patent Application Publication
(10) Pub. No.: US 2026/0131295 A1
(43) Pub. Date: May 14, 2026

(54) JOINED ELECTRICAL COUPLER AND CATALYTIC MATERIAL AND METHOD FOR PRODUCING THEREOF

(71) Applicant: Lydian Labs, Inc., Cambridge, MA (US)

(72) Inventors: Branko Zugic, Cambridge, MA (US); Joseph Rodden, Cambridge, MA (US); Andrew Crampton, Cambridge, MA (US); Sofie Roger, Cambridge, MA (US); James Male, Cambridge, MA (US)

(73) Assignee: Lydian Labs, Inc., Cambridge, MA (US)

(21) Appl. No.: 19/279,728

(22) Filed: Jul. 24, 2025

Related U.S. Application Data
(60) Provisional application No. 63/674,914, filed on Jul. 24, 2024.

(51) Int. Cl. B01J 8/02; B01J 35/31; B01J 35/60

(52) U.S. Cl. CPC B01J 8/0285; B01J 35/31; B01J 35/60; B01J 2208/00415

(57) ABSTRACT

A reaction module can include two or more electric couplers; a porous substrate disposed with catalytic material (e.g. a catalytic element); and a bonding agent coupling the electric couplers to the porous substrate. The bonding agent can be applied in a wet state (e.g., as a paste, slurry, slip, etc.) and cured to form a rigid bond (e.g., via heating and/or chemical treatment). The composition of the bonding agent can be formulated to have substantially the same coefficient of thermal expansion as the electric couplers and the catalytic element during operation of the reaction module (e.g., to mitigate thermal stresses).

### CROSS-REFERENCE TO RELATED APPLICATIONS

This application claims the benefit of U.S. Provisional Application No. 63/674,914 filed 24 Jul. 2024, which is incorporated in its entirety by this reference.

### TECHNICAL FIELD

This invention relates generally to the resistive heating field, and more specifically to a new and useful joint and/or method of use in the resistive heating field.

### BRIEF DESCRIPTION OF THE FIGURES

FIG. 1 is a schematic representation of an example of a joined system.

FIGS. 2A and 2B are pictorial representations of examples of electrical couplers joined to a catalytic element.

FIG. 3 is a schematic representation of an exemplary fixture for forming a joined system.

FIG. 4A is a schematic representation of a variant of a bounding and/or outer perimeter and area of the cross section of a porous component.

FIG. 4B is a schematic representation of variants of the cross sections of the electrode and the catalytic element at an interface.

FIG. 5 is a schematic representation of a variant of a wicking depth.

FIG. 6 is a schematic representation of a variant of flowing a current across the electrodes of a thermal reactor.

FIG. 7 is a schematic representation of a variant of a catalytic element operating at an elevated temperature to promote conversion of reactants to products.

FIG. 8 is a schematic representation of a variant of the method of manufacture.

FIG. 9 is a schematic representation of a variant of curing the bonding agent.

FIG. 10 is a schematic representation of a variant of a joined system.

### DETAILED DESCRIPTION

The following description of the embodiments of the invention is not intended to limit the invention to these embodiments, but rather to enable any person skilled in the art to make and use this invention.

### 1. Overview

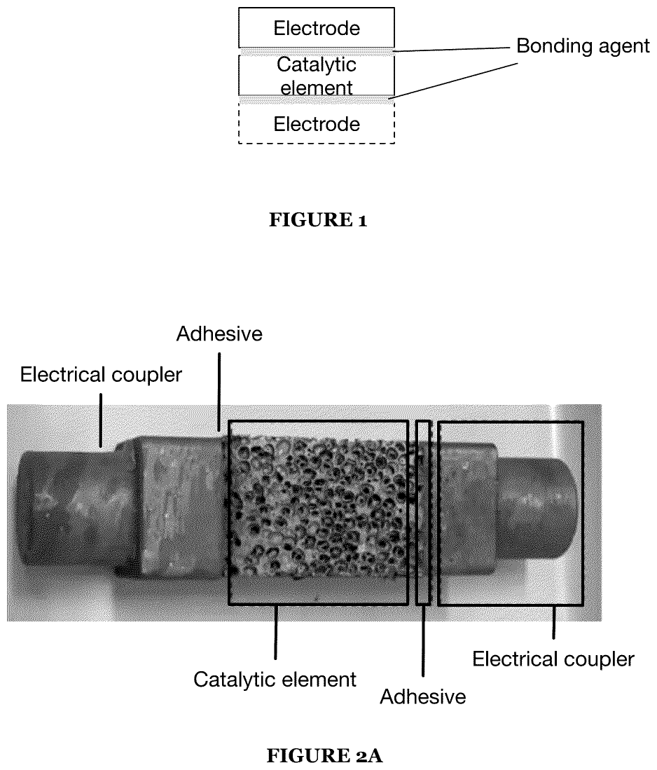

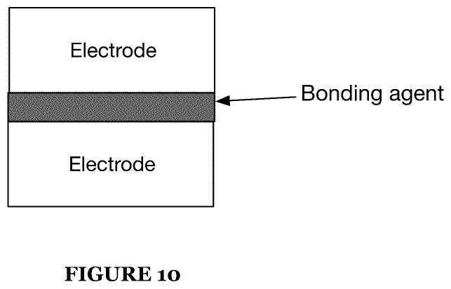

As shown in FIG. 1, the system can include one or more solid components (e.g., electric couplers, electrodes, etc.), one or more porous elements (e.g., catalytic element), and a bonding agent. Additionally or alternatively, the system can include two or more joined porous components (e.g., the electrical coupler can be porous, mesh, fibrous, etc.), two or more joined solid components (e.g., the catalytic element can be replaced by and/or be solid, as shown for example in FIG. 10), and/or can join any suitable components (e.g., inclusive of joining a first segment of a piece to a second segment of the same piece).

In a specific example, a reaction module can include a silicon carbide electric coupler; a silicon carbide porous substrate disposed with catalytic material; and a silicon carbide, silicon, and/or carbon bonding agent (e.g., paste, glue, adhesive, ceramic slurry, etc.) bonding the electric coupler to the porous substrate. However, other suitable reactor configurations, catalytic elements, and/or electrical couplers can be used.

### 2. Technical Advantages

Variants of the technology can confer one or more advantages over conventional technologies.

First, the inventors have found that the operating conditions for thermal reactors can result in degradation of joints and/or bonds holding components of a thermal module together. For instance, adhesives used to join an electrical coupler and a catalytic element can degrade when exposed to the high temperatures (e.g., exceeding 1000° C.), pressures (e.g., exceeding 1 Bar), and/or corrosive fluids (e.g., in the presence of one or more of carbon monoxide, hydrogen, oxygen, ozone, ammonia, carbon dioxide, sulfur oxides, nitrogen oxides, fluorine, chlorine, bromine, iodine, hydrogen sulphide, ethylene oxide, carbonyl sulphide, methyl mercaptan, ethyl mercaptan, propyl mercaptan, butyl mercaptan, hydrogen cyanide, silane, phosphine, water vapor, hydrocarbons, olefins, alcohols, etc.) being reacted within the system. To overcome this, the inventors have found a preferred chemical bonding material (e.g., refractory material for bonding the materials together) for joining these components (and optionally additional or alternative materials that need to be joined in similar or differing environments). For instance, the use of carbon, silicon, and/or composites or alloys thereof (e.g., silicon carbide) as an adhesive can provide electrical contact between the electrical coupler and catalytic element while being resistant to degradation from typical operating conditions (e.g., the bonding material and/or bonding agent can not substantially degrade when exposed to a reactive environment such as a fluid that includes one or more of water, carbon monoxide, carbon dioxide, hydrogen, hydrocarbons, and/or reaction species such as radicals or ions derived therefrom at a temperature between 100° and 1500° C.; where substantial degradation can refer to any removal of the bonding agent and/or bonding material that exceeds about 1 mg/1000 hrs of operation and/or a recession rate of the bonding agent and/or bonding material that exceeds 0.001 to 0.01 mg/cm²/hr and/or 0.05 μm of thickness per hour).

Second, variants of the joining and/or bonding material(s) can be designed to minimize leaching and/or degradation of the materials to be joined (e.g., during the process of joining, curing, etc. the components). For instance, by using a eutectic joining mixture, the joining mixture can have a lower melting and/or softening temperature than the components thereby limiting the leaching of materials from the components to be joined.

Third, variants of the joining materials can include one or more additives that can modify one or more properties (e.g., electrical conductivity, adhesion, oxidative resistance, CTE, melting point, etc.) of the joining material (e.g., modify the absolute properties, modify the properties relative to the catalytic element and/or couplers, etc.). For example, additives can be included such that the catalytic element has a higher resistance than the bonding agent (e.g., is the most resistive component), which can provide an added benefit of minimizing heat generation (e.g., Ohmic loss) outside of the reaction zone.

Fourth, variants of the bonding material can have a paste, slurry, plasticine, and/or slip consistency. As a result, variants of the bonding process can be spatially controlled and localized, minimizing overapplication and ensuring that bonding occurs only where it is structurally or functionally needed. Variants of the bonding material can establish one or more contact points between the electrical coupler and the porous catalytic element to achieve substantially even current distribution (e.g., current distribution variance less than about 20% throughout the catalytic element). In contrast other methods (such as vapor infiltration, diffusion bonding, etc.) can lead to broad or uncontrolled material deposition thereby lacking spatial selectivity, making it difficult to localize bonding and increasing the risk of unintended adhesion, interfacial defects, material waste, pore clogging, and/or other detrimental effects.

However, further advantages can be provided by the system and method disclosed herein.

### 3. Thermal Reactor

The thermal reactor preferably functions to perform (e.g., facilitate, enable, initiate, maintain, etc.) a reaction between two or more chemical species. The chemical species are typically in the fluid phase (e.g., gas, liquid, plasma, etc.). However, one or more chemical species could be solid phase and/or other suitable phase(s) of matter. For example, the thermal reactor can be used to perform a reverse gas water shift reaction (e.g., H₂+CO₂ [symbol] H₂O+CO). Additionally or alternatively, the thermal reactor can be used to perform steam methane reforming (CH₄+H₂O ↔CO+3H₂), dry methane reforming (CH₄+CO₂↔2CO+2H₂), hydrocarbon reforming (e.g. C1-C4 gases, naphtha, etc.), Haber process (N₂+3H₂↔2NH₃), Kværner process (CₙHₘ [symbol] nC+m/2H₂), and/or other suitable industrial processes (particularly using gas phase reactants and ideally gas phase products, endothermic reactions, etc.).

The thermal reactor often operates at standard pressures or greater (e.g., between 1 atm and 300 atm). However (e.g., to control a product ratio, to control a byproduct recovery, etc.), the thermal reactor could be operated under reduced pressure (e.g., vacuum, pressure less than 1 atm, etc.).

Exemplary thermal reactors include reactors as described in U.S. patent application Ser. No. 18/486,328 titled ‘ELECTRICALLY DRIVEN CHEMICAL REACTOR USING A MODULAR CATALYTIC HEATING SYSTEM’ filed 13 Oct. 2023 or International Application No. PCT/US2023/035537 titled ‘SYSTEMS AND METHODS FOR CHEMICAL CATALYTIC PROCESSING’ filed 19 Oct. 2023 each of which is incorporated in its entirety by this reference.

The thermal reactor can include a reaction module (e.g., an electrical coupler or electrode and a catalytic element). The thermal reactor can optionally include one or more of a pressure vessel, interface, compressive element, inlets and/or outlets (e.g., reagent and/or product ports), and/or other suitable elements.

In some variants, the thermal reactor can include a plurality of reaction modules. The plurality of reaction modules can be arranged in parallel (e.g., fluid flows through each reaction module contemporaneously, concurrently, simultaneously, etc.), in series (e.g., fluid from one reaction module to a subsequent reaction module), and/or in any suitable combination thereof (e.g., a plurality of parallel reaction modules where one or more of the plurality include a plurality of reaction modules in series, branching reaction modules, etc.). In some variants, the couplers can be coated with electrically insulating and/or electrically conductive coatings, where the coatings can function to direct the current through the coupler and/or catalytic element in a target manner (e.g., to match current, voltage, etc. capabilities of the power supply being used). The coatings can be applied by various manufacturing processes including electrodeposition, thermal spray, cold spray, brazing, diffusion bonding, melt bonding, alloying, etc. Examples of electrically insulating coatings include one or more of: metal oxides, metal carbides, metal nitrides, mixtures thereof, or any other electrically insulating material. Examples of conductive coatings include: metals (e.g., copper, aluminum, nickel, chromium, tungsten, molybdenum, silicon, gold, silver, titanium, hafnium, platinum, iron, etc.), metal alloys, cermets, conducting metal oxides and/or carbides, and/or other such electrical conductors. In some variants, the conductive coatings can reduce the contact resistance at the interface between the coupler and the catalytic element, facilitating the formation of stable contacts (e.g., to minimize Ohmic losses, undesired local heating outside of the reaction zone, etc.).

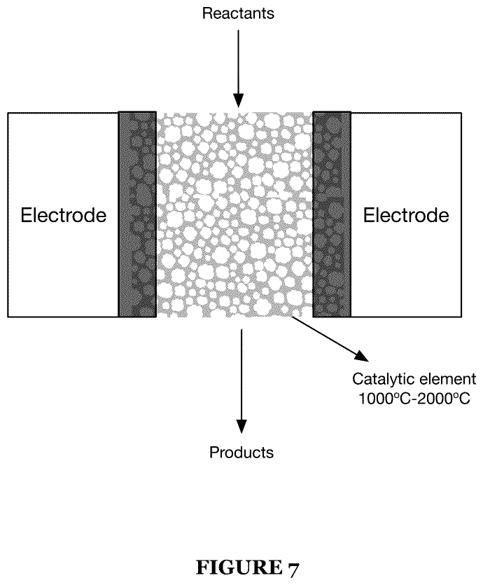

The reaction module preferably functions as a site for chemical reactions to be performed. The reaction module (e.g., a catalytic element thereof) preferably achieves a high operating temperature (e.g., greater than about 500° C., 600° C., 750° C., 800° C., 900° C., 1000° C., 1100° C., 1250° C., 1300° C., 1500° C., 2000° C., 2500° C., etc. as shown for example in FIG. 7), which can be beneficial for driving an equilibrium of the chemical reaction to preferred products. However, the thermal reactor can operate in any suitable manner.

The reactor temperature is preferably achieved via resistive heating (e.g., Joule heating, Ohmic heating, etc.). However, the reactor temperature can otherwise be achieved (e.g., dielectric heating, induction heating, microwave heating, radiative heating, etc. for suitable catalytic elements, reaction modules, etc.).

Energy to achieve the reactor temperature is preferably provided via renewable energy (e.g., in the form of electricity). When Joule heating (resistive heat) is used to power the system, it is preferred that the heat generation is closely coupled to the catalyst material to maximize heat transfer to catalytic sites. This format is characterized in that electrical feedthroughs are included that penetrate the reactor wall and supply large amounts of current and/or electrical power to catalytic elements housed within the reactor.

As shown for example in FIG. 1, a reaction module can include one or more electrodes, one or more catalytic elements, and one or more joining mechanism (e.g., between an electrode and a catalytic element). Typically, the joining mechanism results in the formation of a connected part. However, in some variants, the joining mechanism can result in the formation of an integrated part (e.g., where material from the electrodes and catalytic elements are continuously connected rather than mated via joining material).

The electrical couplers (e.g., electrode) preferably function to provide electricity (e.g., electrical current, electrical energy, etc.) to the catalytic element. The electrical couplers preferably have a lower electrical resistance than the (porous) catalytic element (e.g., so that resistive heating occurs at the catalytic element rather than the electrical coupler). The couplers can interface with external power conductors or with each other. The couplers can be designed to direct the flow of current through the reactor (e.g., catalytic region) in a manner that matches the capabilities (e.g. voltage, current) of the power supply feeding the system while minimizing Ohmic losses. However, the couplers can be designed independent of the power supply.

Typically, two electrical couplers are used for each catalytic element (e.g., one acting as an anode and one acting as a cathode). However, greater numbers of electrical couplers can be used (e.g., a plurality of anodes and/or cathodes) which can be beneficial for improving a uniformity of heating of the catalytic element (e.g., by improving a uniformity of electric current, potential drop, etc. through the catalytic element). In some variants, a single electrical coupler can be used (e.g., where the electrical coupler is designed to have an anode and cathode acting regions and the catalytic element is designed to pass current throughout the catalytic element rather than shorting across a region of the catalytic element proximal the electric coupler).

The electrical coupler is preferably formed wholly or partially from an electrically conductive material. In some variants, the electrical coupler (e.g., surfaces of the electrical coupler not in electrical contact with the catalytic element) can include an insulating material.

The electrical coupler is preferably made of a refractory material (e.g., a semiconducting, electrically conductive, etc. refractory material), metal (e.g., refractory metal), and/or combination thereof (e.g., a cermet material). Preferred examples of electrical coupler materials include: carbon (e.g., graphite electrodes), silicon-carbide (e.g., silicon-silicon carbide, carbon-silicon carbide), tungsten carbide, molybdenum carbide, titanium carbide, vanadium carbide, chromium carbide, zirconium carbide, niobium carbide, molybdenum carbide, ruthenium carbide, rhodium carbide, hafnium carbide, tantalum carbide, rhenium carbide, osmium carbide, iridium carbide, platinum silicide, titanium silicide, vanadium silicide, chromium silicide, zirconium silicide, niobium silicide, molybdenum silicides, ruthenium silicide, rhodium silicide, hafnium silicide, tantalum silicide, tungsten silicide, rhenium silicide, osmium silicide, iridium silicide, neptunium silicide, nitrides, silicon nitride, aluminum nitride, platinum boride, titanium boride, vanadium boride, chromium boride, zirconium boride, niobium boride, molybdenum boride, ruthenium boride, rhodium boride, hafnium boride, tantalum boride, tungsten boride, rhenium boride, osmium boride, iridium boride, neptunium boride, titanium, vanadium, chromium, zirconium, niobium, molybdenum, ruthenium, rhodium, hafnium, tantalum, tungsten, rhenium, osmium, iridium, cobalt, alloys or composites therebetween, and/or other similar materials. In some variations, the reaction module can include conductive metal oxides such as chromium oxide (optionally including magnesium dopants, nickel dopants, etc.), zinc oxide, nickel oxide, titanium oxide, ceria, and may be mixed with other oxides including aluminum oxide, magnesium oxide, zirconium oxide, ruthenium oxide, and mixtures thereof. In some variations, the electrical coupler material can include dopants (e.g., nitrogen, phosphorous, metal dopants, p-type dopants, n-type dopants, etc. such as nickel, iron, arsenic, antimony, bismuth, magnesium, calcium, strontium, barium, lithium, copper, boron, gallium, indium, aluminium, cerium, niobium, etc.) to increase a conductivity of the electrical coupler, to improve a mechanical robustness of the reaction module, to improve a chemical stability of the reaction module, and/or for other suitable purposes (e.g., to modify a dwell time of reactants on a surface of the reaction module). The dopants (e.g., distribution of dopants) can optionally be used to generate or control the local electrical conductivity of the reaction module. As a specific example, the reaction module can be formed from a poorly conductive (e.g., nonconductive) oxides in regions where higher resistance is desired (e.g., in a catalytic region) and as conductive oxides where lower resistance is desired (e.g., in electrical couplers, near regions where electrical contacts are made, etc.).

In some variants, the coupler can include one or more secondary phase (e.g., to enhance electrical conductivity, to enhance chemical stability, to enhance thermal behaviors, etc.).

The electrical coupler can be formed from a single continuous component and/or can be formed by bonding and/or joining a plurality of separate components together (e.g., using a bonding agent, bonding material, joining material, etc. such as described below).

The electrical coupler can be cylindrical, prismatoid (e.g., pyramidal, prismatic, antiprismatic, parallelepipedal, cupolaed, frustral, cube, rectangular prism, triangular prism, pentagonal prism, etc.), toroid (e.g., square toroid, rectangular toroid, hexagonal toroid, degenerate toroid, etc.), conical, and/or can have other suitable shapes (e.g., combinations of the aforementioned shapes).

In variants of the electrical coupler that are formed from silicon carbide (or other related composites or alloys such as siliconized silicon carbide, carbon-doped silicon carbide, etc.), the electrical couplers are preferably substantially fully densified (e.g., solid, density void space of less than about 10%, porosity less than 10%, etc.). As an illustrative example, a silicon carbide coupler can have a density between about 2.5 and about 3.22 g/cm³. In these variants, the silicon carbide can be formed via reaction bonded or siliconized silicon carbide (e.g., silicon carbide where voids or interstitials are filled with silicon). However, other silicon carbide formation methods can be used. For example, sintered silicon carbide and/or recrystallized silicon carbide are other possible variants for the electrical coupler. In some variations, the silicon carbide can include dopants such as boron, nitrogen, phosphorous, and/or other suitable dopants, which can be included to modify sintering properties, electrical conductivity, stability, and/or other properties of the electrical coupler.

In some variants, the electrical coupler can be designed to allow fluid flow therethrough (e.g., have a structure as described for an electrical coupler disclosed in U.S. patent application Ser. No. 18/758,642 titled ‘ELECTRICAL COUPLER FOR RESISTIVELY HEATED REACTOR SYSTEMS’ filed 28 Jun. 2024 which is incorporated in its entirety by this reference.

The catalytic element functions to drive (e.g., increase a reaction rate, decrease a reaction energy barrier, etc.) target chemical reactions. The catalytic element is preferably disposed between at least two electrical couplers (e.g., an anode and a cathode). However, a single electrical coupler (that acts as both cathode and anode) can be used (e.g., when an electrical path through the catalytic element passes through the majority of the volume of the catalytic element before connecting the anode to the cathode). A single coupler or pair of couplers can alternatively be used to join a plurality of elements.

The catalytic element can be cylindrical, prismatoid (e.g., pyramidal, prismatic, antiprismatic, parallelepipedal, cupolaed, frustral, cube, rectangular prism, triangular prism, pentagonal prism, etc.), toroid (e.g., square toroid, rectangular toroid, hexagonal toroid, degenerate toroid, etc.), conical, and/or can have other suitable shapes (typically but not necessarily a 3D shape with two planar broad surface ends).

The catalytic element is preferably partially or wholly formed from an electrically conductive or semiconducting material. However, the catalytic element can additionally or alternatively include electrically insulating material (e.g., to bind catalytic material to a substrate, supports, etc.).

The catalytic element can include: a substrate, a catalyst, and/or any suitable components. In some variants, the substrate can be formed from catalyst material (e.g., the substrate and catalyst can be the same).

The substrate functions to support the catalyst and/or heat the catalyst and/or fluid (e.g., via Joule heating, induction, radiation absorption, etc.). The substrate can additionally or alternatively function to mix the fluid (e.g., by introducing turbulence into the fluid flow), increase a residence time of the fluid proximal the catalyst (e.g., by forming a tortuous pathway through the substrate), and/or can otherwise function.

The substrate is preferably formed from a refractory material, refractory metal, and/or combinations thereof (e.g., cermet). For instance, the substrate can be made from the same or a different material that the electrical coupler can be formed from. In some variations, the substrate material can include dopants (e.g., metal dopants, p-type dopants, n-type dopants, etc. such as nickel, magnesium, lithium, copper, aluminium, cerium, niobium, etc.) to control (e.g., alter, modify, decrease, increase, etc.) a conductivity of the substrate, to improve a mechanical robustness of the reaction module, to improve a chemical stability of the reaction module, and/or for other suitable purposes (e.g., to modify a dwell time of reactants on a surface of the reaction module). Other examples of substrate materials include oxides (e.g., titania, alumina, ceria, zinc oxide, zirconia, silica, etc.), nitrides, carbides, and/or other suitable materials (e.g., which may include dopants to modify the electrical properties of the substrate to promote uniform thermal and/or electrical distributions throughout the catalytic element).

The substrate preferably has a high specific surface area (e.g., to promote reaction sites; including having a high surface roughness or local porosity; etc.) such as ≥0.01 m²/g, ≥0.1 m²/g, ≥1 m²/g, ≥10 m²/g, ≥100 m²/g, ≥1000 m²/g, and/or other surface area (e.g., BET surface area). However, the substrate can have any suitable specific surface area.

The substrate is preferably a porous material (e.g., a material with a porosity greater than 5%, a material with a solid material volume of at most 90%, etc.). As an illustrative example, a silicon carbide substrate can have a density between about 1 and about 2.8 g/cm³. For example, the substrate can be a foam (e.g., open-celled foam, stochastic foam, regular foam, etc.), a woven-fiber, and/or can have any suitable structure. However, the substrate can additionally or alternatively be a solid material (e.g., mesh, ribbon, lattice, periodic open cell structure, etc.), include engineered structures (e.g., a roughened surface to facilitate a large surface area), and/or can otherwise be formed. The porosity and/or engineered structures can be tuned to alter and/or modify fluid dynamics, strength, electrical conductivity, thermal conductivity, local compositions and structures, and/or any other properties to control chemical interactions with the joining material (e.g. infiltration/wicking during curing).

The catalyst functions to reduce an activation energy of a target chemical reaction (e.g., increase a reaction rate, promote reaction centers, etc.). The catalyst is preferably disposed on (e.g., coated on, adhered to, absorbed on, adsorbed on, etc.) the substrate. Additionally, or alternatively, the catalyst can be integrated into the substrate (e.g., where at least a portion of the catalyst material protrudes from the substrate material, can be disposed on the electrical coupler (e.g., to increase the total catalyst loading within the reaction module and/or reactor), and/or can otherwise be arranged.

Examples of catalyst materials (e.g., for the RWGS reaction) can include: oxides (e.g., iron oxide, chromium oxide, copper oxide, aluminium oxide, zinc oxide, cerium oxide, iron oxide, manganese oxide, indium oxide, nickel oxide, spinel oxides, aluminates (e.g., hexaaluminates), solid solution oxides, perovskite-type oxides, composites or combinations thereof, etc.), metal catalysts (e.g., platinum, palladium, gold, rhodium, ruthenium, copper, nickel, rhenium, cobalt, iron, molybdenum, etc.), phosphides (e.g., copper phosphide, nickel phosphide, tungsten phosphide, cobalt phosphide, molybdenum phosphide, combinations thereof, etc.), carbides (e.g., titanium carbide, zirconium carbide, vanadium carbide, hafnium carbide, niobium carbide, tantalum carbide, chromium carbide, molybdenum carbide, tungsten carbide, iron carbide, etc.), carbonates (e.g., sodium carbonate, potassium carbonate, rubidium carbonate, cesium carbonate, calcium carbonate, magnesium carbonate, barium carbonate, strontium carbonate, cobalt carbonate, nickel carbonate, copper carbonate, iron carbonate, etc.), alkali metal promoters, and/or other suitable catalyst materials (e.g., for a specific reaction, combined with a specific substrate material, etc.).

In variants of the catalytic element that use a silicon carbide (or relatedly other carbides replacing silicon for refractory metals, transition metals, etc.) such as for a substrate, the catalytic element can be formed by sintering of silicon carbide powders, carbonizing a silicon (or other precursor metal) foam (or other structure), siliconizing (and/or other metallizing) a carbon mesh (or fiber, porous network, etc.), direct formation (e.g., growth of a silicon carbide or other carbide mesh), and/or in any manner. As a first specific example a substrate can be formed by coating a carbon foam (e.g., reticulated vitreous carbon foam) with silicon carbide (e.g., using chemical vapor deposition). As a second specific example, a substrate can be formed by coating a polyurethane template with silicon and/or silicon carbide (e.g., slip coating), pyrolyzing the polyurethane to carbon (or, alternatively, burning out the polyurethane), and optionally infiltrating the resulting material with silicon and/or sintering the pyrolyzed substrate. In any of these specific examples, the substrate can subsequently be coated with catalytic material (e.g., via chemical vapor deposition, drop-casting, spin coating, etc.). However, the catalytic element can be formed in any manner.

In some variants, the silicon carbide element can be doped during the manufacturing process to control the electrical properties of the substrate. Dopants can include additives such as aluminum oxide, yttrium oxide, erbium oxide, lanthanum oxide, silicon oxide, carbon aluminum nitride, boron nitride, boron carbide, silicon, aluminum, carbon, and/or any other resistive or conductive dopants. Dopants can also be introduced from the gas phase by exposing the sample to dopants such as nitrogen, oxygen, or any other gas phase dopant.

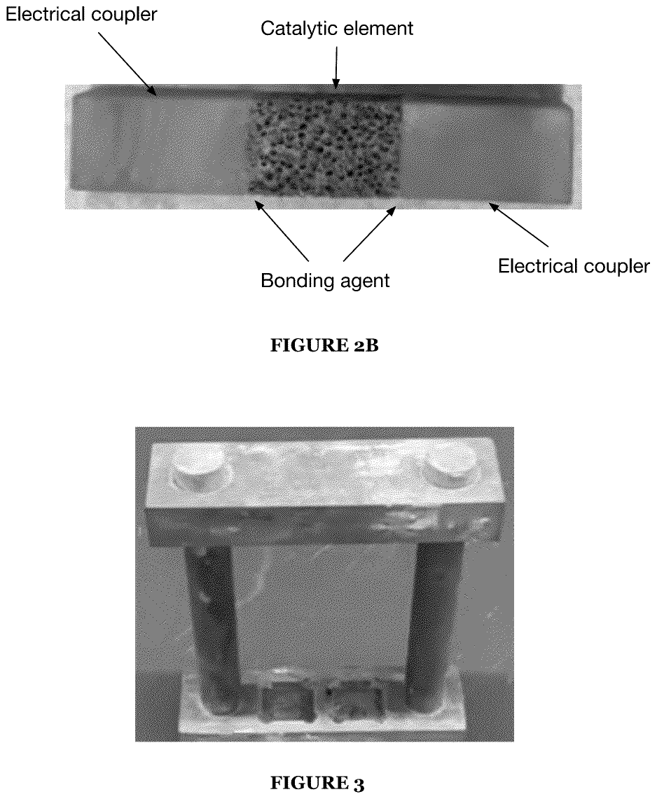

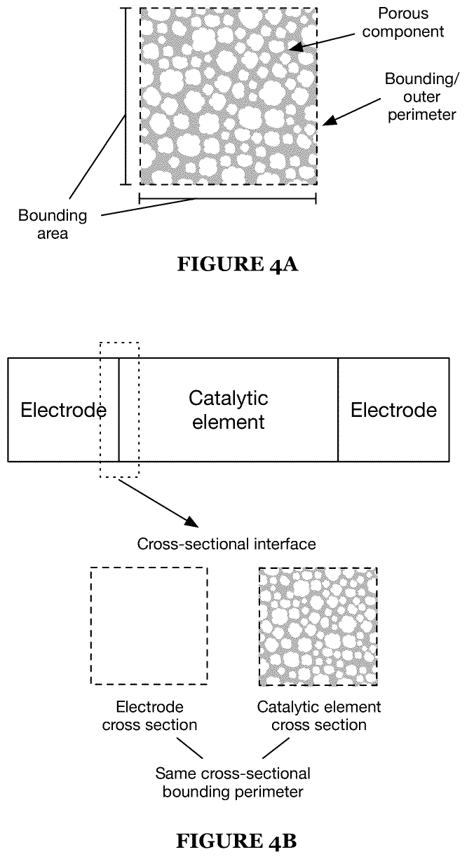

The electrical coupler and the catalytic element preferably have substantially the same cross-sectional geometry (e.g., area, size, shape, perimeter, etc. as shown for example in FIG. 2A or FIG. 2B). Having substantially the same cross-sectional geometry can be beneficial for evenly distributing electrical current within the catalytic element, minimize wasted electrical energy or heat, and/or can simplify mechanical designs (e.g., supports) for the reaction module. For instance, a cylindrical catalytic element is preferably mated to an electrical coupler with a circular cross-sectional area (e.g., conical, cylindrical, etc. such as one differing in cross-sectional area by less than 10% from that of the catalytic element), where the mating occurs at the circular cross-sections. Similarly, a prismatic catalytic element preferably mates to a prismatic electrical coupler (such as one differing in cross-sectional area by less than 10% from that of the catalytic element). However, the cross-sectional shapes can differ (e.g., a prismatic catalytic element can mate to a cylindrical electrical coupler, a cylindrical catalytic element can mate to a prismatic electrical coupler, etc.), the cross-sectional areas can differ (e.g., the catalytic element can have a larger cross-sectional area, the electrical coupler(s) can have a larger cross-sectional area, one electrical coupler can have a larger area and a one electrical coupler can have a smaller area relative to the catalytic element, etc.), and/or the geometries can otherwise be related. In variants in which the catalytic element is porous and/or sponge-like, the catalytic element can have a cross-sectional geometry that has the same bounding perimeter (e.g. outside perimeter) and/or bounding area as that of the electrical coupler, as shown for example in FIG. 4A and FIG. 4B.

The cross-sectional geometry (e.g., area, size, etc.) is preferably substantially constant (particularly but not exclusively for the catalytic element). However, the cross-sectional geometry can vary along an axis perpendicular to the cross-sectional area (e.g., can have a venturi shape to promote higher temperatures in a center of the catalytic element, can have a varying size to promote curvature in the catalytic element, etc.).

The catalytic element and the electrical couplers are preferred chemically connected (e.g., using an adhesive, forming bonds between the electrical coupler and the catalytic element such as the substrate). The catalytic element and the electrical couplers can optionally (in addition to or in the alternative to) be connected mechanically (e.g., physically compressed together such as using a spring, pneumatic systems, hydraulic system, vacuum, motors, etc.) and/or using other suitable mechanisms.

The electrical coupler is preferably bonded to the catalytic element in a way that minimizes the electrical resistance (e.g., minimizes contact resistance or prevents high resistant phases from forming) and/or allows for the stable delivery of high current densities to the catalytic element. These bonding properties can provide a technical advantage as a high local resistance at the contact or contact interface can create hot spots and/or areas prone to degradation under reaction conditions. Local resistance can be minimized by using appropriate geometric design, materials selection, mechanical compression, chemical bonding, and other such processes that ensure intimate electrical and physical contact between the electrical coupler and the catalytic element (e.g., without adding significant stress such as during thermal expansion and contraction).

In a preferred embodiment, the bonding agent is preferably substantially matched to both the electrical coupler and catalytic element coefficient of thermal expansion (CTE) to minimize the stresses or forces exerted on the bonding agent during expansion and contraction of the electrical coupler, bonding agent, and/or catalytic element during heating and cooling. For instance, a CTE of the bonding agent can differ from a CTE of the electrical coupler and/or catalytic element by at most about 10% of the element's value (ppm/° C.). This constraint can be satisfied, for example, by using a bonding material and/or a combination of bonding materials that together produce an effective CTE within the specified range. However, other CTE differences could be realized (e.g., depending on an operating temperature of the reaction module, when an external pressure is exerted on the component to oppose the thermal expansion and/or contraction, etc.). Moreover, the electrical coupler is preferably electrically conductive (e.g., has a lower resistance than the catalytic element) so that the bonding agent does not form a local hot spot or become significantly resistively heated.

The bonding agent (e.g., adhesive) preferably includes (e.g., consists of, composed of, composed essentially of, consists essentially of, includes only, essentially only includes, etc.) the same materials and/or a subset of materials thereof as both the electrical coupler and the catalytic element. As a specific example, for a silicon carbide electrical coupler and silicon carbide substrate of a catalytic element, the bonding agent preferably includes silicon, carbon, or combinations thereof. However, in some variants, different materials can be used as the bonding agent (e.g., any material that the electrical coupler or the substrate can be formed from could be used in some variants as a bonding agent) and/or the bonding agent can include other species (e.g., additives or materials that can react with binders or bonding agents to produce secondary phases or materials such as carbides, borides, silicides, etc.). The bonding agent can be conductive or, alternatively, insulating (e.g., to create a desired flow path through components of the thermal reactor). However, the bonding agent can have any other suitable properties.

In a variant, the bonding agent can have a green state (e.g. an uncured state, an undried state, a wet state, etc.). The green state of the bonding agent can be a mixture (e.g. solution, paste, gel, slurry, slip, powder, etc.) comprising a functional material (e.g., a material and/or mixture of materials that are preferably compatible with the material of the electrical coupler and catalytic element, that form the functional bond and/or joint between the components) and, optionally, a binder and/or solvent. In some variants, the bonding agent can be applied to the foam catalyst material and/or the coupler while the foam catalyst material and/or coupler are in a green state, where during curing the green states for each species are densified. The functional material is preferably conductive and preferably has a similar CTE as that of the electrical coupler and the catalytic element. However, the functional material can have any suitable characteristics. The binder and/or solvent functions to mix with the functional material to form a mixture with target physical properties (e.g. thickness, viscosity, adhesion, etc.).

In a specific variant of a bonding agent, the functional material can be an alloy or mixture (e.g. the functional material can include an alloy or mixture of materials). In these variants, eutectic mixtures are preferred (e.g., to avoid phase segregation), but are not required. For example, an approximately 92 at. % silicon and 8 at. % boron eutectic mixture can be used as a functional material in a bonding agent to form a silicon bonding agent, where percentages in this example generally refer to mole fraction. This example can be advantageous for bonding silicon carbide materials as the eutectic silicon boron material has a lower melting point than silicon and thus the bonding agent can be applied without significantly leaching silicon from the silicon carbide (thereby reducing the electrical conductivity of, modifying mechanical properties of, etc. the electrical coupler or the substrate). However, other eutectics (e.g., silicon phosphorous, silicon iron, silicon aluminium, silicon gold, silicon titanium, silicon hafnium, silicon chromium, silicon germanium, etc.) and/or mixtures can be used in these variants. Similar considerations apply to other electrical coupler or substrate materials (e.g., a silicon-molybdenum eutectic with about 95% molybdenum and about 5% silicon could be used preferably, but not exclusively, when at least one of the electrical couplers and/or the substrate include molybdenum and so on for other materials). In another example, the bonding agent can include a silicon-germanium alloy. In this example, germanium can be added to lower the melting temperature of the bonding agent without the formation of secondary phases in the bonding agent. Lower quantities of germanium (e.g. 0.5%, 1%, 2%, 5%, 10%, etc. by mass and/or by volume) can reduce the melting temperature of the bonding agent while maintaining stability and achieving target conductive and thermal properties.

In some variants, the bonding agent (and/or bonding agent precursor) can include one or more additives. The additives can be designed to react at or below joining temperatures to form at least one secondary phase(s), where the secondary phases can be used to modify properties of the bonding agent or resulting bonded component (e.g., conductivity, CTE, oxidation resistance, brittleness, etc.). The additives can additionally or alternatively be included to reduce (e.g., hinder, prevent, etc.) wicking of the bonding agent into the catalytic element (e.g., porous catalyst bed material, substrate, foam, etc.). Exemplary additives can include molybdenum disilicide, tungsten, tungsten carbide, molybdenum, molybdenum carbide, carbon, other bonding agent materials, electric coupler materials, and/or other suitable additives.

The materials of the bonding agent (e.g. silicon, carbon, boron, silicon alloys, additives, etc.) in the green state can be in the form of particles, flakes, powders, granules, shavings, or any other suitable form. That is, the green state of the bonding agent can be a mixture of particulate matter that cures and/or melts into a functional bond between components. The particulate material can have a particle size between 1 nanometer and 1000 microns (e.g., 1 nanometer, 5 nanometers, 10 nanometers, 0.1 micron, 0.5 micron, 1 micron, 5 microns, 10 microns, 20 microns, 30 microns, 40 microns, 50 microns, 60 microns, 70 microns, 80 microns, 90 microns, 100 microns, 200 microns, 300 microns, 400 microns, 500 microns, 600 microns, 700 microns, 800 microns, 900 microns, 1000 microns, or any suitable value and/or range therebetween). In variants, the particle size can have a bimodal distribution (e.g. comprising a mixture of small and large particles). In this variant, a mixture of small and large particles can minimize voids (e.g., improving density of the binding agent). A particle size ratio in these variants is preferably between 2:1 and 10:1 of large to fine particles (e.g., to achieve a preferred packing density). In variants, a mass ratio of large to small particles can be (e.g., to achieve a preferred packing density) between 10:1 and 1:10 (e.g., 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, 1:10, or any value and/or range therebetween). However, any ratio (e.g., size, mass, etc.) of large and fine particles can be used.

In a specific example, the small particles can have a characteristic size between 1 and 5 μm and the large particles can have a characteristic size between 2 and 50 μm, where the small and large particles are provided with approximately 30-40 wt % small particles and 60-70 wt % large particles.

In some variants, a plurality of bonding agents can be used and/or multiple layers of bonding agents (e.g., joining materials) can be used. These variants can be beneficial for facilitating modification of properties of the bonding agent and/or resulting bonded component such as the electrical conductivity, CTE, oxidative resistance, and/or other suitable property. Each bonding agent and/or layer thereof can be applied in the liquid, solid, and/or gas phase to form such multilayered structures. These structures and/or layers can be formed contemporaneously (e.g., simultaneously, concurrently, within a threshold time, etc.) and/or in separate curing steps.

Additionally, or alternatively, any component can be mechanically coupled such as via a wetted connection, brazing, diffusion bonding, ultrasonic welding and/or other suitable process. For instance, a silicon carbide coating can be ultrasonically welded to one or both of an electrical coupler and/or catalytic element that include silicon carbide.

The bonding agent is preferably applied to the electrical coupler and/or catalytic element in a wet phase (e.g., liquid, solution, mixture, slurry, paste, putty, slip, plasticine, etc.). However, the bonding agent can additionally or alternatively be applied in a solid phase, gas phase (e.g., chemical vapor deposition), plasma phase (e.g., plasma-enhanced CVD), and/or any suitable phases. In a first variant, the bonding agent can be melted to form a liquid that can be applied to the electrical coupler, catalytic element, and/or other suitable component. In another variant, the bonding agent can be dissolved and/or suspended (e.g., dispersed) in a solvent and/or binder to form a paste, where the paste can be applied to the electrical coupler, catalytic element, and/or other suitable component.

Examples of solvents and/or binders include alcohols (e.g., furfuryl alcohol, ethoxylated furfuryl alcohol, ethanol, phenol, methanol, 2-(2-methoxyethoxy)ethanol, 1-propanol, 2-propanol, 1,3-propanediol, 1-butanol, 2-butanol, 2-methyl-1-propanol, 2-methyl-2-propanol, 1,4-butanediol, 1,2,4-butanetriol, 2-methyl-1-butanol, 2-methyl-2-butanol, 1-pentanol, 3-methyl-1-butanol, 3-methyl-2-butanol, 2,2-dimethyl-1-propanol, cyclopentanol, neopentyl alcohol, 2-methyl-1-pentanol, 1-hexanol, cyclohexanol, 2-ethylhexanol, heptanol, octanol, nonanol, decanol, 2-propene-1-ol, benzyl alcohol, phenylmethanol, diphenylmethanol, triphenylmethanol, glycerol, ethylene glycol, propylene glycol, polyalcohols, etc.), ethers (e.g., dimethyl ether, methylethyl ether, diethyl ether, methyl propyl ether, ethylpropyl ether, dipropyl ether, dibutyl ether, dimethoxyethane, dimethoxymethane, diisopropyl ether, tert-amyl ethyl ether, tert-amyl methyl ether, cyclopentyl methyl ether, di-tert-butyl ether, di(propylene glycol) methyl ether, 1,4-dioxane, ethyl tert-butyl ether, methyl tert-butyl ether, 2-methyltetrahydrofuran, morpholine, polyethylene glycol, propylene glycol methyl ether, tetrahydrofuran, tetrahydrofurfuryl alcohol, tetrahydropyran, 2,2,5,5-tetramethyltetrahydrofuran, etc.), esters (e.g., benzyl benzoate, bis(2-ethylhexyl) adipate, bis(2-ethylhexyl) phthalate, bis(2-ethylhexyl) terephthalate, 2-butoxyethanol acetate, butyl acetate, sec-butyle acetate, tert-butyl acetate, diethyl carbonate, dimethyl dimethyl adipate, ethyl acetate, ethyl acetoacetate, ethyl butyrate, ethyl lactate, ethylene carbonate, hexyl acetate, isoamyl acetate, isobutyl acetate, isopropyl acetate, methyl acetate, methyl lactate, methyl phenylacetate, methyl propionate, propyl acetate, propylene carbonate, triacetin, etc.), ketones (e.g., acetone, acetonphenone, butanone, cyclopentanone, ethyl isopropyl ketone, 2-hexanone, isophorone, beta-isophorone, mesityl oxide, methyl isobutyl ketone, methyl isopropyl ketone, 3-methyl-2-pentanone, 2-pentanone, 3-pentanone, etc.), aldehydes (e.g., formaldehyde, acetaldehyde, propionaldehyde, butyraldehyde, isovaleraldehyde, benzaldehyde, furfural, methylbenzaldehyde, etc.), halogenated solvents, and/or other suitable solvent(s) (particularly, but not exclusively, volatile or volatilizable solvents and/or polar solvents). In some variations of the first or the second specific example, other agents and/or combinations of solvents can be added to the mixture (e.g., to improve rheological properties such as viscosity, wetting properties, binder properties, etc.) such as polymers (e.g., cellulosic ethers such as methyl cellulose, ethyl cellulose, etc.; phenolic resin; polypropylene carbonate; etc.), solvents (e.g., butyl acetate), plasticizers (e.g. polyethylene glycol) and/or other suitable additives. In some variations of the first or second specific example, additives that can be pyrolyzed (such as polymers or other organic materials) can be included in the solution and/or with the bonding agent where the application of the bonding agent can include pyrolyzing the agents (e.g., by heating to above a threshold temperature such as 500° C. thereby forming carbon or carbon bonding agent composites which can be beneficial for improved stability, electrical conductivity, etc.).

In a specific example of making a bonding agent, elemental materials and/or the functional materials (e.g. Si, Si and B in a eutectic mixture, etc.) are mixed with an optional binding agent (e.g. a cellulosic ether) and solvent (e.g., furfuryl alcohol, ethanol) using 40-95 weight % of the elemental material, 0-20 wt. % of the binder material, and 5-60 wt. % of the solvent. The elemental materials are typically added as powders or granules (e.g., fine particles). The components can be combined, for instance, by mixing by hand and/or mixing with a mechanical mixer, kneader, or mill (e.g., ball mill, shaker mill, etc.). Mixing the components can optionally happen in multiple steps. In one such example, elemental and/or functional materials can be first milled (e.g. in a ball mill, etc.) to uniformly mix the elemental and/or functional materials and achieve a preferred target particle size. In this example, a binder and/or solvent can then be added. In this example, the mixing can be performed at room temperature or at an elevated temperature (where the elevated temperature can improve binder solubility and/or introduce gelation and where the elevated temperature is typically less than the boiling temperature of the solvent at atmospheric pressure). The resulting mixture can have a plasticine-like consistency (e.g., paste, flocculated suspension of solid in liquid, organocolloid gel, viscoelastic material, rheid, slurry, etc.) which can be easily manipulated or formed into desired shapes while largely retaining shape during transportation and handling. In variants, a thicker paste consistency is desirable because it can be easily localized and/or contained to a specific region without flowing and/or moving (e.g., without wicking into the porous material more than a threshold distance). In variants, the mixture can have a viscosity between 10⁻⁵ and 10⁸ Pa·s. For example the mixture can have has a paste-like consistency (e.g., a viscosity between 1 Pa·s and 10³ Pa·s), a putty-like consistency (e.g., a viscosity between 10³ Pa·s and 10⁵ Pa·s), a slurry-like consistency (e.g., a viscosity between 10⁻⁵ Pa·s and 1 Pa·s), or plasticine-like consistency (e.g., a viscosity between 10⁵ Pa·s and 10⁸ Pa·s). However, the mixture can have any suitable viscosity.

The resulting mixed joining material can be applied to the surfaces to be joined via tape casting, doctor blading, extrusion, rolling, a template which allows for easy spreading or application of the joining material, and/or any other process (e.g., a process that produces a uniform thickness of joining material across the surfaces to be joined when a uniform application is desired).

In variants, the joining material (e.g. bonding agent in a green state and/or wet phase) can be applied to the electrical coupler and/or catalytic element to form a layer. The layer can have a uniform thickness, or alternatively, can have variable thickness. The layer can have a thickness between 1 micron and 5 mm (e.g., 1 micron, 5 microns, 10 microns, 50 microns, 100 microns, 200 microns, 300 microns, 400 microns, 500 microns, 600 microns, 700 microns, 800 microns, 900 microns, 1 mm, 1.1 mm, 1.2 mm, 1.3 mm, 1.4 mm, 1.5 mm, 1.6 mm, 1.7 mm, 1.8 mm, 1.9 mm, 2 mm, 3 mm, 4 mm, 5 mm, or any value and/or range therebetween).

In variants, the joining material can be applied on the entire interface between the catalytic element and the electrical couplers. In other variants, the bonding agent can be applied on specific regions of the interface (e.g. a dot at the center of the interface, to form patterns at the interface, etc.). However, the joining material can be applied in any suitable method.

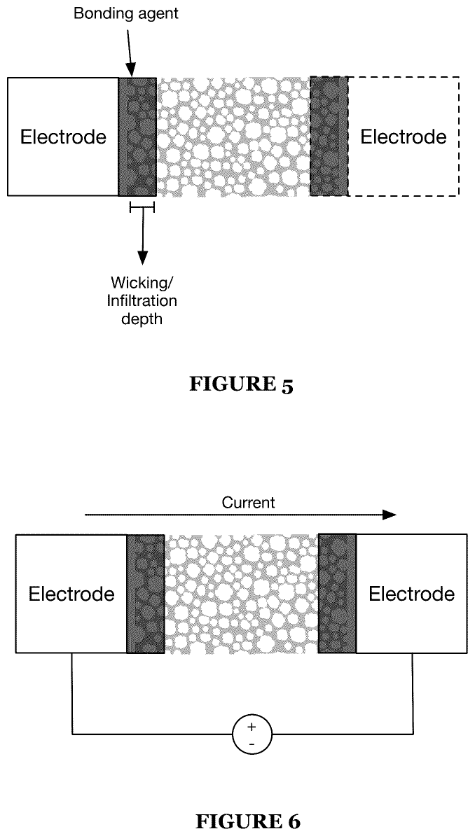

In variants in which the catalytic element and/or electrical coupler are porous, the joining material can infiltrate (e.g. seep into, penetrate, embed into, wicking into, etc.) the pores of the components. This penetration can function to increase the contact between the bonding agent and the catalytic element (e.g. to ensure electrical contact, to provide enhanced mechanical stability, etc.). Various processing steps (e.g. heating, pressurizing, etc.) can be performed in order to achieve a desirable amount of wicking and/or infiltration during joining. Additionally or alternatively, the joining agent solution can be tuned for wicking behaviour (e.g., bonding agent particle size, viscosity, layer thickness, etc.) and/or infiltration can otherwise be modified. Additionally or alternatively, the catalytic element and/or electrical coupler can be produced in way (e.g., with a specific structure and/or geometry, with a specific composition, etc.) to impart an interaction (e.g., chemical, mechanical, etc.) to control wicking and/or infiltration. Wicking and/or infiltration can be characterized by a wicking depth (e.g. the distance in which the joining material seeps into a porous component), as shown for example in FIG. 5. The wicking depth can be between 0.1 mm and 10 cm (e.g. 0.1 mm, 0.5 mm, 1 mm, 2 mm, 3 mm, 4 mm, 5 mm, 6 mm, 7 mm, 8 mm, 9 mm, 1 cm, 2 cm, 3 cm, 4 cm, 5 cm, 6 cm, 7 cm, 8 cm, 9 cm, 10 cm, or any value and/or range therebetween). However, infiltration and/or wicking can be otherwise characterized.

In a variant, multiple joining mixtures can be applied to form the bonding agent. For example, a silicon paste and a germanium paste can each be applied to an application region. In this variant, the pastes can melt together during a curing process to form a homogenous bonding agent material. In another variant, the different materials can stay localized, resulting in a bonding agent with different localized mechanical properties dependent on the different materials used. However, joining mixtures can be otherwise applied to form the bonding agent.

The bonding agent is preferably applied (and cured) in an inert environment (e.g., vacuum, helium, neon, argon, krypton, xenon, radon, etc.), which can be beneficial for minimizing or hindering side reactions from occurring (which may reduce the stability of the bonding agent). However, the bonding agent could be applied and/or cured in a reactive environment (e.g., an environment that includes one or more reactive species such as nitrogen, oxygen, etc. where the reactive species can be introduced during or after curing such as to form an insulating coating on a surface of the bonding agent like an oxide or nitride), and/or can be applied and/or cured in any suitable environment.

In some variants, the bonding agent can be formed and/or applied by infiltrating components with a common infiltrate material (e.g., co-infiltration). For example, a carbon electrical coupler and porous carbon substrate (e.g., carbon foam) can be held in contact and infiltrated with silicon (e.g., liquid silicon infiltration such as melt infiltration, vapor infiltration, etc.), where the silicon and/or resulting silicon carbide can act as bonding agent.

Curing the bonding agent can include heating the bonding agent (e.g., to melt the bonding agent, to evaporate solvent from the bonding agent, to pyrolyze additives, etc.), cooling the bonding agent (e.g., to solidify molten bonding agent material), applying pressure (e.g., during curing process or prior to complete curing applying a force to the components to be bonded, generating a vacuum to facilitate solvent evaporation, etc.), and/or other suitable steps or processes.

During curing, the components (e.g., with bonding agent in between) are preferably held using a fixture (or other suitable apparatus), that can function to maintain an alignment, spacing, and/or contact between the components (e.g., until the bonding agent is cured and can retain the components on its own). The fixture (or other apparatus) is preferably made from a material that can withstand the curing temperatures (e.g., a graphite fixture can be used when silicon bonding agents are used as graphite has a higher sublimation temperature than the melting temperature of silicon, as shown for example in FIG. 3, etc.). However, other suitable fixtures can be used.

The fixture preferably uses the force of gravity to compress the components together (e.g., an electrical coupler, bonding agent, catalytic element, bonding agent, and electrical coupler are preferably stacked parallel to a gravity vector during curing). However, other suitable arrangements (e.g., perpendicular to a gravity vector, at an angle relative to a gravity vector, etc.) can be used. In other variants, the components can be held together and/or forced together using a mechanical force. For example, a mechanical force can be applied to force the components together. This can cause bonding agent to be squeezed from the interface between components or for the bonding agent to infiltrate porous components. Typically, when a plurality of components are to be bonded together (e.g., two electrical couplers independently bonded to a catalytic element), the components are all bonded and cured concurrently. However, the bonding (e.g., curing) can be performed sequentially. While not present in all instantiations, wicking of the bonding agent into porous components (e.g., catalytic element) can occur prior to curing. In some variants, the curing process (e.g., temperature, time, etc.), bonding agent precursor (e.g., inclusion of additives, formulation, concentration, etc.) can be modified to mitigate the wicking of bonding agent (and/or its precursor) into the catalytic element. Additionally or alternatively, the amount of bonding agent precursor used can be controlled to modify the extent of wicking that is possible (while ensuring a sufficiently resilient bond is formed). However, the curing process may be independent of any potential wicking.

Heating the bonding agent functions to melt the joining material and/or bonding agent and to, optionally, evaporate solvent from the bonding agent and/or pyrolyze or otherwise remove additives. In variants in which the bonding agent comprises multiple functional materials (e.g. silicon and molybdenum, silicon and germanium, silicon and boron), heating the bonding agent can induce a reaction between (e.g., sinter, anneal, etc.) the functional materials. Heating the bonding agent can be performed in a furnace and/or heating chamber. In another variant, heating the bonding agent can be achieved through hot pressing. The bonding agent can be heated to a temperature above the solidus temperature and/or melting temperature of the functional materials of the bonding agent (e.g. silicon). In variants wherein the bonding agent comprises silicon, the heating temperature can be between 900° C. and 2000° C. (e.g. 900° C., 1000° C., 1100° C., 1200° C., 1300° C., 1400° C., 1500° C., 1600° C., 1700° C., 1800° C., 1900° C., 2000° C., or any range and/or value therebetween).

Heating the bonding agent can be performed for a heating duration and/or holding time. The heating duration can be between 0.01 and 200 minutes. The heating duration can be tuned to achieve certain amounts of wicking and/or infiltration of the bonding agent into porous components. For example, the inventors have found that shorter holding times (e.g. 20 minutes or less, etc.) can lead to less wicking and/or infiltration, while longer holding times (e.g. 60 minutes or more, etc.) can contribute to more wicking and infiltration. Additionally, longer holding times may be used (e.g., to thoroughly melt the bonding agent in variants in which the bonding agent is applied in a thick layer, to ensure additives are substantially fully removed or degraded, etc.).

Heating the bonding agent can be done in multiple heating steps to describe a firing profile. In variants, heating the bonding agent can include heat ramping steps and holding steps. For example, during ramping, the temperature can be controlled to slowly or quickly increase the temperature of the bonding agent. Slow heating can be performed to minimize thermal stresses and thermal shock and can assist in the proper release of gases from any residual organics. Various heating steps (e.g. different holding temperatures) can be used to achieve the formation of different phases, microstructures, mechanical properties, and physical properties. As a specific example, the bonding agent can be heated to (and held at) a first temperature (e.g., a boiling point of the solvent at a given pressure), followed by heating to a second temperature for a second duration (e.g., a pyrolyzing temperature of an additive, an annealing temperature, etc.).

In variants, heating the bonding agent can include pressuring the furnace. For example, the furnace can be pressurized with high pressures to induce isostatic pressure on the bonding agent (which can provide a technical advantage to keep the bonding agent localized between the coupler and the catalytic element). In another example, a negative pressure and/or vacuum environment can be established in the furnace to encourage the bonding agent to infiltrate porous components (e.g. to achieve a desired wicking depth). A pressure of the inert atmosphere (e.g., within the furnace) can be between 10⁻⁶ Torr and 7600 Torr. However, the bonding agent may be applied in different pressures (e.g., depending on temperature, composition, etc.).

In variants, heating the bonding agent can include introducing a gaseous species (e.g. oxygen, nitrogen, argon, etc.) to induce chemical reactions. For example, in variants in which the bonding agent comprises silicon, nitrogen and/or oxygen can be introduced to the furnace during heating to form silicon nitride, silicon oxynitride, and/or silicon oxide respectively. In another example, oxygen can be introduced to oxidize carbon and other species to change the electrical resistance of the material. The bonding agent can be heated in an inert atmosphere (e.g., nitrogen, argon, etc.) to maintain the presence of carbon after the pyrolysis of organics. The carbon can suppress wicking or form SiC or other carbides at the joint. Alternatively, heating in air can be performed to remove any excess carbon (e.g., via oxidation of the pyrolyzed carbon). However, heating the bonding agent can be otherwise performed.

Curing the bonding agent can further comprise cooling the bonding agent after heating. In variants, the curing process can result in binders and/or solvents evaporating and/or degrading and the bonding material to melt into a unitary bond between the components. Cooling the bonding agent functions to allow the molten material to harden. Once cooled, the cured bonding agent is preferably solid and forms a rigid bond (e.g., mechanically stable, enabling electrical communication between or electricity to flow through or between, etc.) between the components. During operation of the thermal reactor, the bonding agent in this cured state can function to hold the catalytic element and electrical couplers together, carry current across the components, and remain thermally stable in the reactive environment.

The thermal reactor can be used to perform various chemical reactions. Performing chemical reactions can be performed by heating the catalytic element (e.g. resistively heating, etc.) and introducing gaseous reactants to the thermal reactor. In variants, a voltage can be applied between the electrical couplers to create a current that flows from the first electrical coupler, through the bonding agent, into the catalytic element, and to the second electrical coupler through the bonding agent, to resistively heat the catalytic element, as shown for example in FIG. 6. Predominantly after (but potentially during and/or before) the catalytic element has achieved a target operating temperature, gaseous reactants (e.g. H₂, CO₂, CH₄, CO, H₂O, etc.) can be introduced to the thermal reactor. Introducing gaseous reactants can include flowing the reactant through, around, and/or over the heated catalytic element at a suitable flow rate and/or pressure. Through this process and/or any other suitable method, the thermal reactor can be used to perform reverse gas water shift reactions (e.g., H₂+CO₂ [symbol] H₂O+CO), steam methane reforming (CH₄+H₂↔CO+3H₂), dry methane reforming (CH₄+CO₂↔2CO+2H₂), hydrocarbon reforming (e.g. C1-C4 gases, naphtha, etc.), Haber process (N₂+3H₂↔2NH₃), Kværner process (CₙHₘ [symbol] nC+m/2H₂), and/or other suitable industrial processes (particularly using gas phase reactants and ideally gas phase products, endothermic reactions, etc.).

### 4. Method

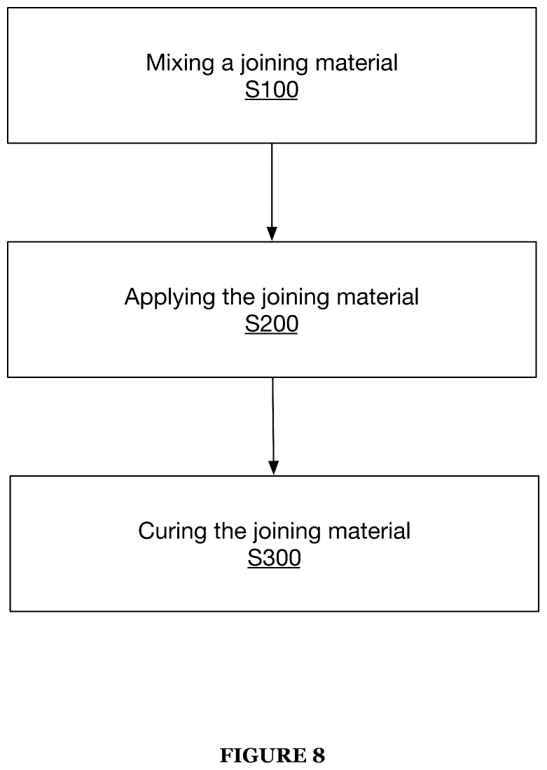

The method functions to form a bond of a thermal reaction module. The method can be performed to produce a reaction module (e.g., electrified thermal reactor, electrical coupler(s) bonded to catalytic foam, etc.) such as described above. The method can include mixing a joining material S100, applying the joining material S200, and curing the joining material to form the bonding agent S300, as shown for example in FIG. 8. However, the method can additionally or alternatively include any suitable steps. The method can be used to form an airtight and conductive joint between components. For example, the method can be used to form a unified part of the thermal reactor comprising the catalytic elements and the electrical couplers. However, the method can be used to join any suitable components.

Mixing a joining material S100 can function to create a material that can be used to make the bonding agent. The joining material can include a functional material and, optionally, a binder and/or solvent. The functional material can be in the form of clumps, chunks, flakes, powders, particulates, and/or any suitable geometry. The functional material preferably has substantially the same CTE (e.g., a CTE differing by at most about 10%) as the components to be bonded together (e.g. to prevent thermally-induced internal stresses during operation of the thermal reactor). Additionally, in variants wherein the method is used to form electrically conductive bonds, the functional material can be electrically conductive (and/or semiconducting such as with an electrical conductivity of at least 100 S/m). In a variant, the functional material can be the same and/or a similar material to those in the components of the thermal reactor. For example, in variants in which a silicon carbide coupler is bonded to a silicon carbide catalytic element, the functional material can include silicon, carbon, and/or silicon carbide. The functional material can include one or a plurality of materials (e.g. elements, compounds, alloys, etc.). The functional material can include any suitable materials previously mentioned or any suitable material.

In variants, the joining material can include a binder and/or solvent. The binder and/or solvent function to alter the physical properties and/or consistency of the joining material. The binder and/or solvents can be a liquid used to form a mixture (e.g. paste, slurry, putty, plasticine, etc.) with the functional material. The binder and/or solvent can include alcohols, ethers, ketones, aldehydes, polymers, solvents, carbonates, and/or any suitable material. However, the binder can be any suitable material or any previously mentioned suitable material.

In other variants, the joining material can include additives. The additives can function to alter the physical, chemical, and/or electrical properties of the bonding agent and/or joining material. For example, the additives can function to increase and/or decrease the electrical conductivity of the bonding agent, increase and/or decrease the melting point of the bonding agent, increase and/or decrease the strength of the bonding agent, and/or any suitable function. In variants wherein the functional material is silicon, some additives can include carbon, germanium, and/or molybdenum. In other variants, additives can include conductive fillers, metallic particles (e.g. nanoparticles), fibers, fillers, plasticizers, reinforcing resins, flame retardants, thermal stabilizers, crosslinkers, curing agents, and/or any suitable additive. However, the additive can be any suitable material or any previously mentioned suitable material.

Mixing the joining material can be performed by a mixer, a mill, a kneader, a blender, and/or any suitable equipment. Mixing the joining material can optionally include milling the materials. For example, the functional material and/or additives can be milled to thoroughly mix the components and, optionally, reduce the particle size. In variants, mixing the joining material can occur in stages. For example, solid components can be mixed and/or milled together before the addition of liquid components (e.g. solvents, binders, etc.) However, mixing the joining material can be performed using any set of suitable steps.

Mixing the joining material can be performed consistently, intermittently, sporadically, or in any other suitable routine. Mixing the joining material can be performed until the joining material is homogenous and/or for a predetermined duration of time. For example, the joining material can be mixed for a duration between 5 seconds and 24 hours (e.g. 5 seconds, 10 seconds, 30 seconds, 1 minute, 2 minutes, 3 minutes, 4 minutes, 5 minutes, 10 minutes, 20 minutes, 30 minutes, 1 hours, 2 hours, 3 hours, 4 hours, 5 hours, 10 hours, 24 hours, etc.). However, the joining material can be mixed for any suitable duration of time.

Applying the joining material S200 can function to localize the joining material to a region in which a bond is desired. The joining material can be applied to the surfaces to be joined via tape casting, doctor blading, extrusion, smearing, painting, rolling, a template which allows for easy spreading or application of the joining material, and/or any other process (e.g., a process that produces a uniform thickness of joining material across the surfaces to be joined if a uniform application is desired). The joining material can be applied as a layer. In variants, the joining material can be as a layer with a thickness (e.g. average distance, maximum distance, minimum distance) between 1 micron and 5 mm (e.g., 1 micron, 5 microns, 10 microns, 50 microns, 100 microns, 200 microns, 300 microns, 400 microns, 500 microns, 600 microns, 700 microns, 800 microns, 900 microns, 1 mm, 1.1 mm, 1.2 mm, 1.3 mm, 1.4 mm, 1.5 mm, 1.6 mm, 1.7 mm, 1.8 mm, 1.9 mm, 2 mm, 3 mm, 4 mm, 5 mm, or any value and/or range therebetween). However, the joining material can be applied in any suitable method.

Applying the joining material can include arranging the components to be bonded. In a variant, the joining material can first be applied to an electrical coupler. Subsequently, the joining face of the catalytic element can be placed, such that the joining material is between the catalytic element and the electrical coupler. A frame and/or support can be used to hold the components in place and/or align the components. Optionally, a force may be applied to hold the components together. The force can be applied using weights, clamps, pistons, and/or using any other suitable methods. However, the components can be positioned, aligned, and/or held together, using any suitable process.

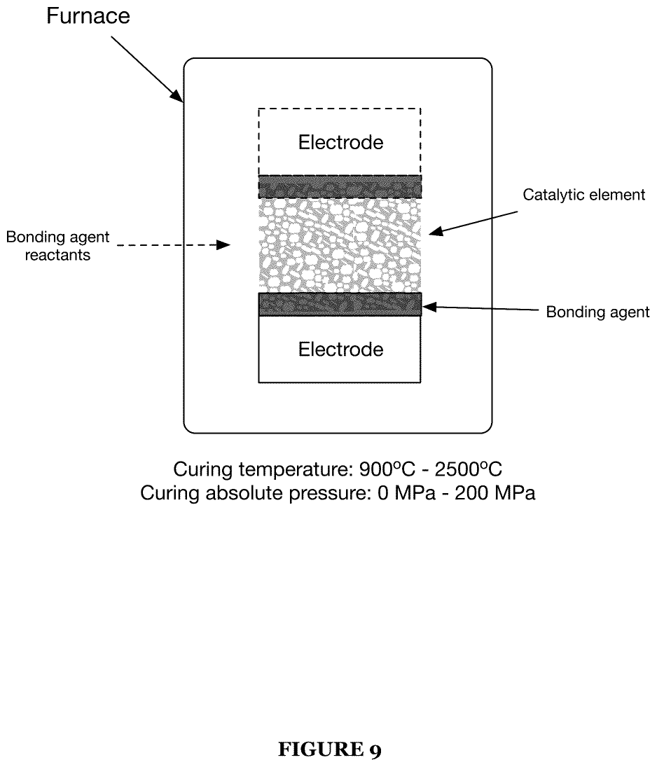

Curing the joining material S300 can function to solidify the joining material. Curing the joining material can include heating the joining material and/or, optionally, treating the joining material, as shown for example in FIG. 9. Curing the joining material can be performed in a furnace, heating chamber, reaction chamber, or any suitable equipment. The curing step can be performed in a suitable environment. The bonding agent can be cured in an inert environment (e.g., vacuum, helium, neon, argon, krypton, xenon, radon, etc.), which can be beneficial for minimizing or hindering side reactions from occurring (which may reduce the stability of the bonding agent). However, the bonding agent could be applied and/or cured in a reactive environment (e.g., an environment that includes one or more reactive species such as nitrogen, oxygen, etc. where the reactive species can be introduced during or after curing such as to form an insulating coating on a surface of the bonding agent like an oxide or nitride), and/or can be cured in any suitable environment.

Curing the joining material can be performed in a high pressure environment or a low pressure environment. The inventors have found that establishing a low pressure environment in the curing chamber can cause the joining material to infiltrate or wick into porous components (e.g. porous catalytic element, etc.). Conversely, the inventors have found that establishing a high pressure environment can hinder wicking and/or infiltration.

Heating the joining material can be performed at any suitable temperature. The temperature for curing can be dependent on the melting temperature and/or solidus temperature of the joining material and the components to be joined. The curing temperature is preferably higher than the melting, solidus, and/or sintering temperature of the joining material but lower than the melting and/or solidus temperature of the joined components. For example, in variants in which the joining components are made of silicon carbide and the bonding agent comprises silicon, a curing temperature can be between 900° C. and 2000° C.

Heating the bonding agent can be performed for a curing duration and/or holding time. The heating duration can be between 0.01 and 200 minutes. The heating duration can be tuned to achieve certain amounts of wicking and/or infiltration of the bonding agent into porous components. For example, the inventors have found that shorter holding times (e.g. 20 minutes or less, etc.) can lead to less wicking and/or infiltration, while longer holding times (e.g. 60 minutes or more, etc.) can contribute to more wicking and infiltration. Additionally, longer holding times may be used to thoroughly melt the bonding agent in variants in which the bonding agent is applied in a thick layer.

Heating the bonding agent can be done in multiple heating steps to describe a firing profile. In variants, heating the bonding agent can include heat ramping steps and holding steps. For example, during ramping, the temperature can be controlled to slowly or quickly increase the temperature of the bonding agent. Slow heating can be performed to minimize thermal stresses and thermal shock. Various heating steps (e.g. different holding temperatures) can be used to achieve the formation of different phases, microstructures, mechanical properties, and physical properties.

In variants, curing the bonding agent can include introducing a gaseous species (e.g. oxygen, nitrogen, etc.) to induce chemical reactions. For example, in variants in which the bonding agent comprises silicon, nitrogen and/or oxygen can be introduced to the furnace during heating to form silicon nitride and/or silicon oxide respectively. In another example, oxygen can be introduced to oxidize carbon and other species to change the electrical resistance of the material.

Curing the bonding agent can include cooling the bonding agent after heating. Cooling can be performed in the heating equipment or in any suitable location. Cooling the bonding agent can be performed slowly in a furnace via a cooling profile. For example, cooling the bonding agent can include holding the bonding agent at specified temperatures at decreasing increments in order to equilibrate the bonding agent to room temperature to prevent thermal shock. In other variants, the bonding agent can be air-cooled, furnace-cooled, passively cooled, quenched, or any suitable method. Once cooled the bonding agent is preferably solid and forms a rigid bond between the components. During operation of the thermal reactor, the bonding agent in this cured state can function to hold the catalytic element and electrical couplers together, carry electric current across the components, and remain thermally stable in the reactive environment.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the preceding system and/or method can be used with, in addition to, in lieu of, or otherwise integrated with all or a portion of the systems and/or methods disclosed in the applications mentioned above, each of which are incorporated in their entirety by this reference.

As used herein, “substantially” or other words of approximation (e.g., “about,” “approximately,” etc.) can be within a predetermined error threshold or tolerance of a metric, component, or other reference (e.g., within 0.001%, 0.01%, 0.1%, 1%, 5%, 10%, 20%, 30% of a reference), or be otherwise interpreted.

As a person skilled in the art will recognize from the previous detailed description and from the figures and claims, modifications and changes can be made to the preferred embodiments of the invention without departing from the scope of this invention defined in the following claims.

### 5. Specific Examples

Specific Example 1. A thermal reactor comprising:
a first electrical coupler;
a second electrical coupler; and
a porous catalytic element; wherein the first and second electrical couplers are electrically mated to opposing faces of the porous catalytic element via respective bonding agents; wherein an electrical current is applied between the first and second electrical couplers such that the electrical current passes through the porous catalytic element and the associated bonding agents to resistively heat the porous catalytic element.

Specific Example 2. The thermal reactor of Specific Example 1, wherein the bonding agents, the porous catalytic element, the first electrical coupler, and the second electrical coupler each comprise a shared conductive material.

Specific Example 3. The thermal reactor of Specific Example 2, wherein the shared conductive material is silicon.

Specific Example 4. The thermal reactor of Specific Example 1, wherein a cross-section of the first electrical coupler, a cross-section of the second electrical coupler, and a cross-section of the porous catalytic element, each comprise substantially the same outer perimeter.

Specific Example 5. The thermal reactor of Specific Example 1, wherein the porous catalytic element has a density between 0.95 and 2.6 g/cm³, wherein the first electrical coupler and the second electrical couple each have a density between 2.8 and 3.21 g/cm³.

Specific Example 6. The thermal reactor of Specific Example 1, wherein the bonding agents does not substantially degrade in the presence of water, carbon dioxide, carbon monoxide, or hydrogen at temperatures below 1500° C.

Specific Example 7. The thermal reactor of Specific Example 1, wherein the bonding agents penetrates pores of the porous catalytic element to a depth between 1 and 5 mm.

Specific Example 8. A method for operating a thermal reactor comprising:
resistively heating a foam catalytic element to a temperature between 1000° C. and 1500° C.;
flowing a reactant through the foam catalytic element, wherein a reactant comprises at least one of water, carbon dioxide, carbon monoxide, or hydrogen; wherein the thermal reactor comprises:
the foam catalytic element;
a first electrode bonded to a first face of the foam catalytic element via a bonding agent; and
a second electrode bonded to a second face of the foam catalytic element via the bonding agent;
   wherein the method can be performed on the thermal reactor for over a thousand hours without degradation of the foam catalytic element, the bonding agent, or the electrodes.

Specific Example 9. The method of Specific Example 8, wherein coefficient of thermal expansion of the first electrode, the second electrode, and the foam catalytic element differ by at most 5% between 20° C. and 1500° C.

Specific Example 10. The method of Specific Example 8, wherein flowing the reactant through the foam catalytic element facilitates at least one of: a reverse gas water shift reaction, steam methane reforming, dry methane reforming, hydrocarbon reforming, the Haber process, or the Kværner process.

Specific Example 11. The method of Specific Example 8, wherein the foam catalytic element, the first electrode, and the second electrode, each comprise silicon carbide, wherein the bonding agent comprises silicon.

Specific Example 12. The method of Specific Example 8, wherein the first electrode and second electrode are solid (e.g., porosity 10%), wherein the foam catalytic element comprises a porosity between 30% and 90%.

Specific Example 13. The method of Specific Example 8, wherein the bonding agent is not substantially heated via Joule heating resulting from electricity flowing between the electrical coupler and the foam catalytic element through the bonding agent.

Specific Example 14. A method comprising:
applying a layer of a conductive bonding agent to an electrical coupler, wherein the conductive bonding agent comprises a bonding material and a binder, wherein the layer comprises a thickness between 100 microns and 2 mm;
coupling a conductive porous element to the electrical coupler, wherein the layer of the conductive bonding agent is located at an interface between the conductive porous element and the electrical coupler; and
heating the conductive bonding agent to a curing temperature for a duration between 1 and 120 minutes; wherein the curing temperature is above a solidus temperature or sintering temperature of the bonding material and below a melting temperature of the conductive porous element;
   wherein the bonding material, electrical coupler, and the conductive porous element, have substantially the same coefficient of thermal expansion at temperatures between 20° C. and 1500° C.

Specific Example 15. The method of Specific Example 14, wherein the conductive bonding agent (e.g., with a viscosity of 10⁻⁵-10⁸ Pa·s at 25° C., at a bonding temperature, or at another suitable reference temperature) has a paste-like consistency (e.g., a viscosity between 1 Pa·s and 10³ Pa·s), putty-like consistency (e.g., a viscosity between 10³ Pa·s and 10⁵ Pa·s), a slurry-like consistency (e.g., a viscosity between 10⁻⁵ Pa·s and 1 Pa·s), or plasticine-like consistency (e.g., a viscosity between 10⁵ Pa·s and 10⁸ Pa·s).

Specific Example 16. The method of Specific Example 14, wherein the bonding material comprises silicon particles.

Specific Example 17. The method of Specific Example 16, wherein bonding material further comprises at least one of: molybdenum, geranium, carbon, or boron.

Specific Example 18. The method of Specific Example 14, wherein the binder comprises at least one of: furfuryl alcohol, butyl acetate, methylcellulose, ethanol, phenolic resin, propylene carbonate, tall oil, or polypropylene carbonate.

Specific Example 19. The method of Specific Example 14, further comprising: applying pressure to the conductive bonding agent during heating.

Specific Example 20. The method of Specific Example 14, further comprising: introducing reactive gas during heating; wherein the reactive gas comprises at least one of oxygen, methanecarbon, or nitrogen.

We claim:

1. A thermal reactor comprising:
a first electrical coupler;
a second electrical coupler; and
a porous catalytic element; wherein the first and second electrical couplers are electrically mated to opposing faces of the porous catalytic element via respective bonding agents;
wherein an electrical current is applied between the first and second electrical couplers such that the electrical current passes through the porous catalytic element and the associated bonding agents to resistively heat the porous catalytic element.

2. The thermal reactor of claim 1, wherein the bonding agents, the porous catalytic element, the first electrical coupler, and the second electrical coupler each comprise a shared conductive material.

3. The thermal reactor of claim 2, wherein the shared conductive material is silicon.

4. The thermal reactor of claim 1, wherein a cross-section of the first electrical coupler, a cross-section of the second electrical coupler, and a cross-section of the porous catalytic element, each comprise substantially the same outer perimeter.

5. The thermal reactor of claim 1, wherein the porous catalytic element has a density between 0.95 and 2.6 g/cm³, wherein the first electrical coupler and the second electrical couple each have a density between 2.8 and 3.21 g/cm³.

6. The thermal reactor of claim 1, wherein the bonding agents do not substantially degrade in the presence of water, carbon dioxide, carbon monoxide, or hydrogen at temperatures below 1500° C.

7. The thermal reactor of claim 1, wherein the bonding agents penetrate pores of the porous catalytic element to a depth between 1 and 5 mm.

8. A method for operating a thermal reactor comprising:
resistively heating a foam catalytic element to a temperature between 1000° C. and 1500° C.;
flowing a reactant through the foam catalytic element, wherein a reactant comprises at least one of water, carbon dioxide, carbon monoxide, or hydrogen;
wherein the thermal reactor comprises:
the foam catalytic element;
a first electrode bonded to a first face of the foam catalytic element via a bonding agent; and
a second electrode bonded to a second face of the foam catalytic element via the bonding agent;
wherein the method can be performed on the thermal reactor for over a thousand hours without substantial degradation of the foam catalytic element, the bonding agent, or the electrodes.

9. The method of claim 8, wherein a coefficient of thermal expansion of the first electrode, the second electrode, and the foam catalytic element differ by at most 5% between 20° C. and 1500° C.

10. The method of claim 8, wherein flowing the reactant through the foam catalytic element facilitates at least one of: a reverse gas water shift reaction, steam methane reforming, dry methane reforming, hydrocarbon reforming, the Haber process, or the Kværner process.

11. The method of claim 8, wherein the foam catalytic element, the first electrode, and the second electrode, each comprise silicon carbide, wherein the bonding agent comprises silicon.

12. The method of claim 8, wherein the first electrode and second electrode are solid, wherein the foam catalytic element comprises a porosity between 30% and 90%.

13. The method of claim 8, wherein the bonding agent is not substantially heated via Joule heating resulting from electricity flowing between the electrical coupler and the foam catalytic element through the bonding agent.

14. A method comprising:
applying a layer of a conductive bonding agent to an electrical coupler, wherein the conductive bonding agent comprises a bonding material and a binder, wherein the layer comprises a thickness between 100 microns and 2 mm;
coupling a conductive porous element to the electrical coupler, wherein the layer of the conductive bonding agent is located at an interface between the conductive porous element and the electrical coupler; and
heating the conductive bonding agent to a curing temperature for a duration between 1 and 120 minutes; wherein the curing temperature is above a solidus temperature or a sintering temperature of the bonding material and below a melting temperature of the conductive porous element;
wherein the bonding material, electrical coupler, and the conductive porous element, have substantially the same coefficient of thermal expansion at temperatures between 20° C. and 1500° C.

15. The method of claim 14, wherein the conductive bonding agent has a paste-like, slurry-like, or plasticine-like consistency.

16. The method of claim 14, wherein the bonding material comprises silicon particles.

17. The method of claim 16, wherein bonding material further comprises at least one of: molybdenum, geranium, carbon, or boron.

18. The method of claim 14, wherein the binder comprises at least one of: furfuryl alcohol, butyl acetate, methylcellulose, ethanol, phenolic resin, propylene carbonate, tall oil, or polypropylene carbonate.

19. The method of claim 14, further comprising: applying pressure to the conductive bonding agent during heating.

20. The method of claim 14, further comprising: introducing reactive gas during heating; wherein the reactive gas comprises at least one of oxygen, methane, or nitrogen.
